(19) United States
(12) Patent Application Publication
(10) Pub. No.: US 2015/0310073 A1
(43) Pub. Date: Oct. 29, 2015

(54) FINDING PATTERNS IN A KNOWLEDGE BASE TO COMPOSE TABLE ANSWERS

(71) Applicant: MICROSOFT CORPORATION, REDMOND, WA (US)

(72) Inventors: Kaushik Chakrabarti, Redmond, WA (US); Surajit Chaudhuri, Redmond, WA (US); Bolin Ding, Redmond, WA (US); Mohan Yang, Los Angeles, CA (US)

(73) Assignee: MICROSOFT CORPORATION, REDMOND, WA (US)

(21) Appl. No.: 14/264,995

(22) Filed: Apr. 29, 2014

(51) Int. Cl. G06F 17/30

(52) U.S. Cl. CPC G06F 17/30539; G06F 17/30864; G06F 17/30327

(57) ABSTRACT

In general, the knowledge base table composer embodiments described herein provide table answers to keyword queries against one or more knowledge bases. Highly relevant patterns in a knowledge base are found for user-given keyword queries. These patterns are used to compose table answers. To this end, a knowledge base is modeled as a directed graph called a knowledge graph, where nodes represent entities in the knowledge base and edges represent the relationships among them. Each node/edge is labeled with a type and text. A pattern that is an aggregation of subtrees which contain all keywords in the texts and have the same structure and types on node/edges is sought. Patterns that are relevant to a query for a class can be found using a set of scoring functions. Furthermore, path-based indexes and various query-processing procedures can be employed to speed up processing.

### BACKGROUND

It has become common place to search for information on the World Wide Web by submitting a keyword search query to a search engine. Many of the most popular commercial search engines use and maintain high-quality structured data in the form of knowledge bases to return answers to these keyword queries. In general, such knowledge bases contain information about individual entities together with attributes representing relationships among them.

Often the best answer to a keyword query may not be found in a single webpage or a single tuple in a database. Users often look for information about multiple entities and would like to see the aggregations of results. For example, an analyst may want a list of companies that produce database software along with their annual revenues for the purpose of market research. Or a student may want a list of universities in a particular county along with their enrollment numbers, tuition fees and financial endowment in order to choose which universities to seek admission to.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In general, the knowledge base table composer embodiments described herein provide table answers to keyword queries against one or more knowledge bases.

In some embodiments of the knowledge base table composer, highly relevant patterns in a knowledge base are found for user-given keyword queries. These patterns are used to compose table answers. A knowledge base is modeled as a directed graph called knowledge graph, where nodes represent entities in the knowledge base and edges represent the relationships among them. In one embodiment, each node/edge is labeled with a type and text. The knowledge base table composer seeks a pattern that is an aggregation of subtrees which contain all keywords in the texts and have the same structure and types on node/edges. Patterns that are relevant to a query can be found using a set of scoring functions. In some embodiments, path-based indexes and different query-processing procedures can be employed to speed up processing.

### DESCRIPTION OF THE DRAWINGS

The specific features, aspects, and advantages of the disclosure will become better understood with regard to the following description, appended claims, and accompanying drawings where:

FIGS. 1A, 1B and 1C depict entities and their associated attributes in a knowledge base.

FIG. 1D depicts part of a knowledge graph derived from the knowledge base in FIGS. 1A through 1C, and subtrees (T1-T3) matching the query “database software company revenue”.

FIGS. 2A and 2B depict tree patterns for FIG. 1A {T1, T2} and FIG. 1B {T3}.

FIG. 3 provides an example of a table aggregating the subtrees of the tree pattern in FIG. 2A.

FIG. 4 depicts a flow diagram of an exemplary process for practicing one embodiment of the knowledge base table composer described herein.

FIG. 5 depicts a flow diagram of another exemplary process for practicing another embodiment of the knowledge base table composer described herein.

FIG. 6 depicts a system for implementing one exemplary embodiment of the knowledge base table composer described herein.

FIG. 7A depicts a pattern-first path index. The diagram depicts indexing patterns of paths ending at each word w with a length of no more than d.

FIG. 7B depicts a root-first path index. The diagram depicts indexing patterns of paths ending at each word w with a length of no more than d.

FIG. 8A depicts a pattern first path index for the word “database” for the knowledge graph shown in FIG. 1D.

FIG. 8B depicts a root-first path index for the word “database” for the knowledge graph shown in 1D.

FIG. 9 is a schematic of an exemplary computing environment which can be used to practice various embodiments of the knowledge base table composer.

### DETAILED DESCRIPTION

In the following description of knowledge base table composer embodiments, reference is made to the accompanying drawings, which form a part thereof, and which show by way of illustration examples by which the knowledge base table composer embodiments described herein may be practiced. It is to be understood that other embodiments may be utilized and structural changes may be made without departing from the scope of the claimed subject matter.

### 1.0 Knowledge Base Table Composer

The following sections provide an introduction and overview of the knowledge base table composer embodiments described herein, as well as exemplary implementations of processes and an architecture for practicing these embodiments. Details of various embodiments and exemplary computations are also provided.

As a preliminary matter, some of the figures that follow describe concepts in the context of one or more structural components, variously referred to as functionality, modules, features, elements, etc. The various components shown in the figures can be implemented in any manner. In one case, the illustrated separation of various components in the figures into distinct units may reflect the use of corresponding distinct components in an actual implementation. Alternatively, or in addition, any single component illustrated in the figures may be implemented by plural actual components. Alternatively, or in addition, the depiction of any two or more separate components in the figures may reflect different functions performed by a single actual component.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented in any manner.

1.1 Introduction and Overview

In the knowledge base table composer embodiments described herein, keyword queries of one or more knowledge bases are used to create tables that answer the queries. In general, a knowledge base contains information about individual entities together with attributes representing relationships among them. A knowledge base is modeled as a directed graph, called a knowledge graph, with nodes representing entities of different types and edges representing relationships, i.e., attributes, among entities.

The knowledge base table composer finds relevant aggregations of substructures in a knowledge graph for a given keyword query. Each answer to the keyword query is an aggregation of subtrees—each subtree containing all keywords and satisfying the same pattern (i.e., with the same structure and same types on nodes/edges). Such an aggregation or pattern can be output as a table of joined entities, where each row corresponds to a subtree. When there are multiple possible patterns, they can be enumerated and ranked by their relevance to the query.

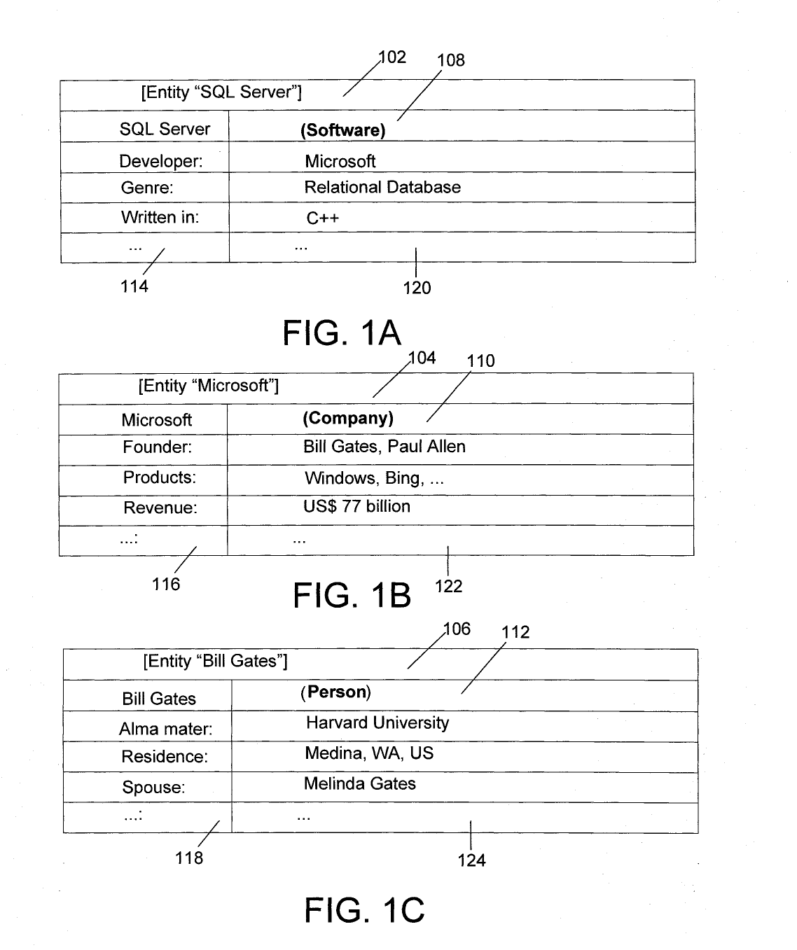

FIGS. 1A, 1B and 1C show a small piece of a knowledge base with three entities 102, 104, 106. For each entity (e.g., ‘SQL Server’ 102, ‘Microsoft’ 104, and ‘Bill Gates’ 106), its type 108, 110, 112 is shown (e.g., Software, Company, and Person, respectively), as is a list of attributes 114, 116, 118 (left column in FIGS. 1A, 1B and 1C together with their values 120, 122, 124 (right column)). The value of an attribute may either refer to another entity, e.g., ‘Developer’ of ‘SQL Server’ is ‘Microsoft’, or be plain text, e.g., ‘Revenue’ of ‘Microsoft’ is ‘US$77 billion’.

As discussed above, a knowledge base can be modeled as a direct graph called a knowledge graph. FIG. 1D shows part of such a knowledge graph 130. Each entity (for example, 132) has a corresponding text description (for example, 132a, 132b, 132c) and corresponds to a node labeled with its type (for example, 134a, 134b, 134c). Each attribute of the entity corresponds to a directed edge (for example, 136a, 136b, 136c, 136d, 136e), also labeled with its attribute type, from the node pointing to some other entity or plain text.

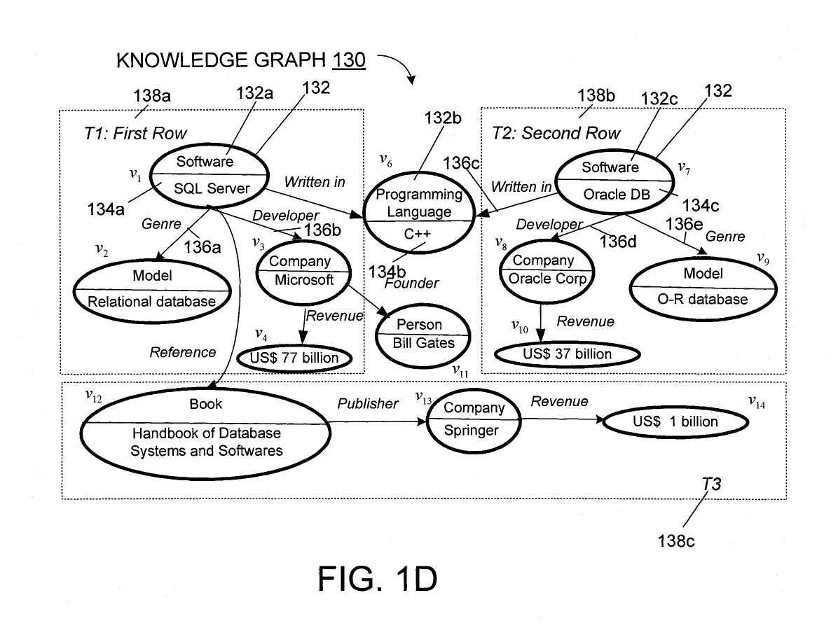

The knowledge base table composer exploits the relationship between queries, subtrees, and tree patterns. Consider a keyword query “database software company revenue”. Three subtrees (T₁, T₂, and T₃) matching the keywords in the query are shown using dashed rectangles 138a, 138b, 138c in FIG. 1D. In subtrees T₁ and T₂, ‘database’ is contained in the text of the some entities; ‘software’ and ‘company’ match to the types' names; and ‘revenue’ matches to an attribute. Also, the structures of T₁ and T₂ are identical in terms of the types of both nodes and edges and how nodes of different types are connected, so they belongs to the same pattern 202 as shown in FIG. 2A. Similarly, T₃ belongs to the tree pattern 204 as shown in FIG. 2B.

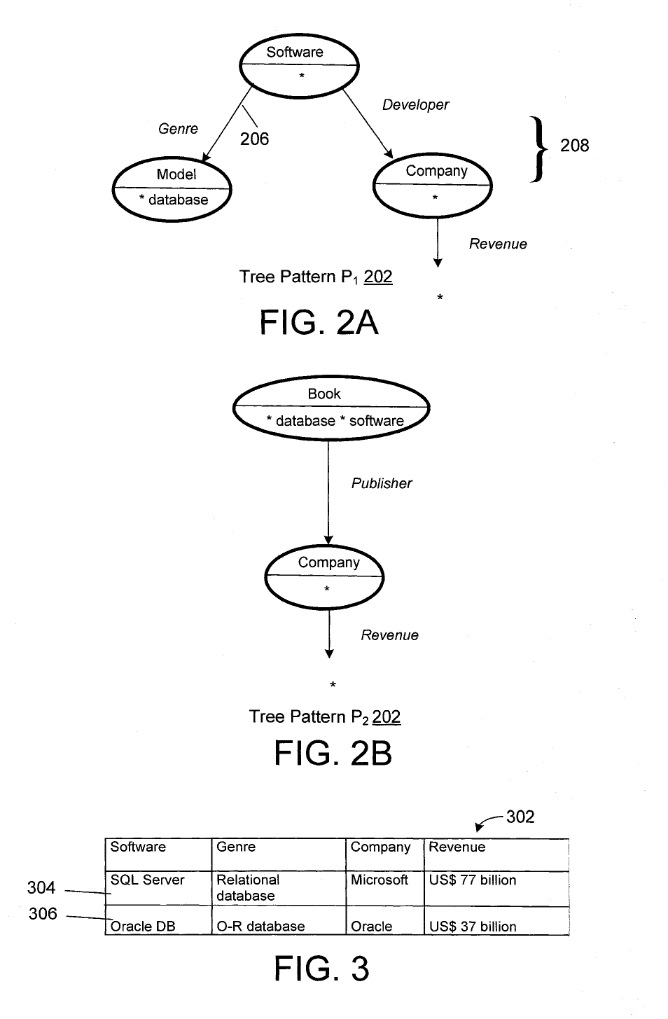

The knowledge graph table composer uses patterns to discover answers to the query. A tree pattern corresponds to a possible interpretation of a keyword query, by specifying the structure of subtrees as well as how the keywords are mapped to subtrees. For example, the tree pattern P₁ 202 in FIG. 2A interprets the query as: the revenue of some company which develops database software; and the pattern P₂ 204 in FIG. 2B is interpreted as: the revenue of some company which publishes books about database software. Subtrees of the same tree pattern can be aggregated into a table as one answer to the query, where each row corresponds to a subtree. For example, subtrees (T₁ and T₂) 206, 208 of the pattern in FIG. 2A can be assembled into the table 302 (the first row 304 and second row 306) in FIG. 3.

As discussed previously, tree patterns can be defined as answers to a keyword query in a knowledge graph. The knowledge base table composer uses a class of scoring functions to measure the relevance of a pattern with respect to a given query.

There are usually a number of tree patterns for a keyword query. The knowledge base table composer uses procedures to enumerate these patterns and to find the top number of relevant tree patterns (e.g., top-k). This can be a hard problem because counting the number of paths between two nodes in the graph can be difficult. Hence, embodiments of the knowledge base table composer can use two types of path-pattern based inverted indexes: paths starting from a node/edge containing some keyword and following certain patterns that are aggregated and materialized in the index in memory. When processing a keyword query, by specifying the word and/or the path pattern, a search algorithm can retrieve the corresponding set of paths using the indexes.

Two procedures for finding the relevant tree patterns for a keyword query that may be used in embodiments of the knowledge base table composer based on such indexes are discussed below.

The first procedure enumerates the combinations of root-leaf path patterns in tree patterns, retrieves paths from the index for each path pattern, and joins them together on a root node to get the set of subtrees satisfying each tree pattern. Its worst-case running time is exponential in both the index size and the output size. When there are m keywords and each has p path patterns in the index, the knowledge base table composer checks all of the p^{m} combinations in the worst case; but it is possible that there is no subtree satisfying any of these tree patterns. Although join operations are wasted on “empty patterns”, the advantage of this procedure is that all subtrees with the same pattern are generated at one time.

The second procedure tries to avoid unnecessary join operations by first identifying all candidate roots with the help of path indexes. Each candidate root reaches every keyword through at least one path pattern, so there must be some tree pattern containing a subtree with this root. Those subtrees are enumerated and aggregated for each candidate root. The running time of this procedure can be shown to be linear in the index size and the output size. To further speed it up, the knowledge base table composer can sample a random subset of candidate roots (e.g., 10% of them), and obtain an estimated score for each pattern based on them. Only for the patterns with the highest top-k estimated scores, does the knowledge base table composer retrieve the complete set of subtrees, and compute the exact scores for ranking.

Embodiments of the knowledge base table composer provide for many advantages. Unlike table search engines which search for existing HTML tables, the knowledge base table composer composes new tables from patterns in knowledge bases in response to keyword queries. These new tables are cleaner and better maintained than existing HTML Web tables. The knowledge base table composer enumerates and ranks patterns of subtrees in knowledge graphs—each pattern aggregates a set of subtrees with the same shape and interpretation to the keyword query to create new tables.

1.2 Exemplary Processes

An overview of embodiments of the knowledge base table composer having been provided, the following paragraphs discuss exemplary processes for practicing some embodiments of the knowledge base table composer.

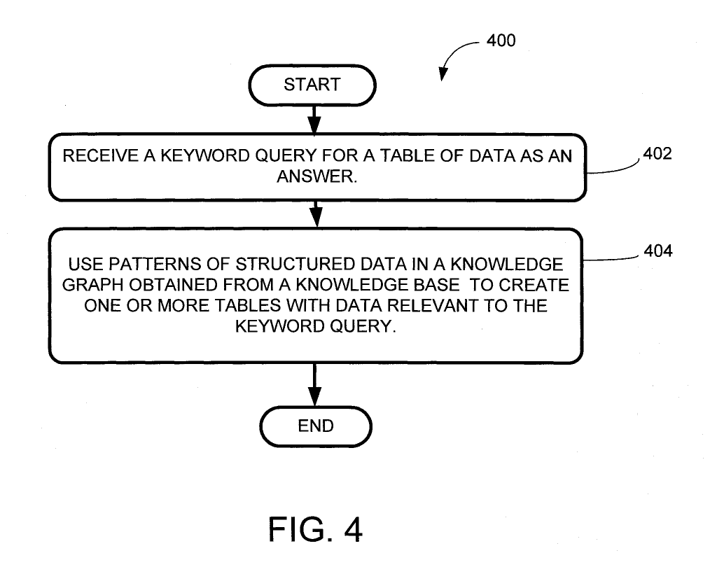

FIG. 4 depicts an exemplary process 400 for creating a table by querying a knowledge base. As shown in block 402, a keyword query is received. The query could relate to information that is desired in the format of a table of data.

As shown in block 404, patterns of structured data in a knowledge graph obtained from a knowledge base are used to create one or more tables with data relevant to the keyword query. The one or more tables can be assembled from one or more subtrees of the knowledge graph. As discussed above, each subtree can be in the form of a directed graph, called a knowledge graph, with nodes representing entities of different types and edges representing relationships, i.e., attributes among entities. Furthermore, each answer to the keyword query is an aggregation of subtrees—each subtree contains all keywords of the keyword query and satisfies the same pattern (i.e., with the same structure and the same types of nodes and edges). Each table can be assembled from the subtrees of the knowledge graph that are connected trees that have the same pattern and the same mapping of keywords to column names, table names and cell values.

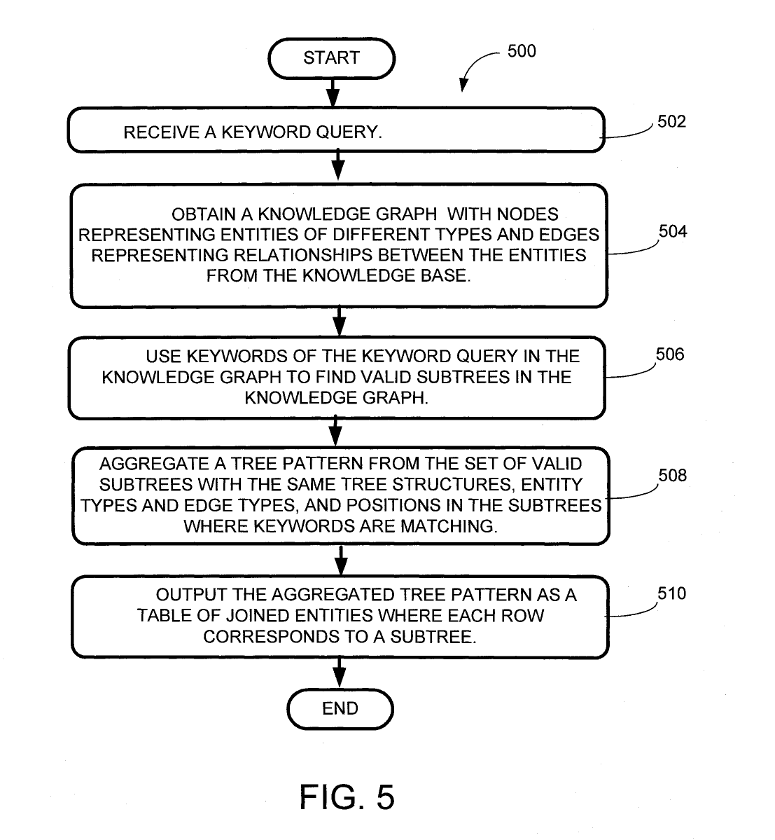

FIG. 5 depicts another exemplary process 500 for practicing the knowledge base table composer. As shown in block 502, a query of a knowledge base is received. A knowledge graph corresponding to keywords in the keyword query with nodes representing entities of different types and edges representing relationships between the entities is obtained from the knowledge base, as shown in block 504. In some embodiments the knowledge graph is a directed graph where each node is an entity with a text description of the value of the entity and its entity type, and where each edge is labeled with a text description of its edge type. It is possible for multiple edges to have the same edge type label. Patterns of keywords in the knowledge graph are used to find relevant subtrees in the knowledge graph, as shown in block 506. A valid subtree pattern relevant to a keyword query is found by finding a subtree that contains all keywords in a given keyword query in the text description of its node, node type or edge type. The valid subtrees are aggregated (as shown in block 508). That is a tree pattern is aggregated from the set of valid subtrees with the same tree structures, entity types and edge types, and positions in the subtrees where keywords are matching. The aggregated tree pattern is output as a table of joined entities where each row corresponds to a subtree (as shown in block 510). Where there are multiple possible patterns, they can be enumerated and ranked by their relevance. For example, the valid subtrees may be scored to measure their relevance to the given keyword query. The relevance score of the tree pattern is an aggregation of the relevance scores of valid subtrees that satisfy the tree pattern.

Path patterns that contain a certain keyword can be indexed. Embodiments of the knowledge base table composer can use different types of indexes. In one embodiment a pattern-first path index is generated. In this type of index paths are sorted by patterns first and then paths. In this type of pattern-first index it is possible to access the paths in different ways. For example, it is possible to retrieve all path patterns for paths from a root node to a node or an edge that contains a query keyword. It is also possible to retrieve all path patterns for paths form a root node to a node or an edge that contains a query keyword via a given path pattern. Additionally it is also possible to retrieve all path patterns with a given path pattern that start at a root node and end at a node or an edge containing a query keyword.

In another root-first path index paths are sorted by root nodes first and then patterns. In this type of root-first index it is also possible to access the paths in different ways. For example, it is possible to retrieve all root nodes that have paths that can reach a node or edge that contains a query keyword. Likewise, it is possible to retrieve all patterns following which a root node can reach a node or an edge that contains a query keyword. Another possibility is to retrieve all paths that start at a root node and end at a node or edge that contains a query keyword. Finally, it is also possible to retrieve all paths with a given pattern that start at a root node and end at a query keyword.

It is possible to aggregate the indexes of path patterns of trees starting from a node or an edge containing some keyword and following a certain pattern. In any of the indexing methods, a keyword query can be processed by specifying a keyword or a path pattern and using a search procedure to retrieve a corresponding set of paths.

There are also different ways in which the most relevant tree patterns for a keyword query can be found. In one embodiment of the knowledge base table composer the relevant tree patterns for a keyword query can be found by enumerating combinations of root-leaf path patterns in tree patterns; retrieving paths from the index for each path pattern; and joining the retrieved paths together on the root node to get a set of subtrees satisfying each tree patterns. Alternately, the relevant tree patterns for a keyword query can be found by identifying all candidate root nodes and enumerating all tree patterns containing a subtree with a given candidate root. The enumerated tree patterns are then aggregated.

Exemplary processes for practicing the technique having been provided, the following section discussed an exemplary system for practicing the technique.

1.3 An Exemplary System

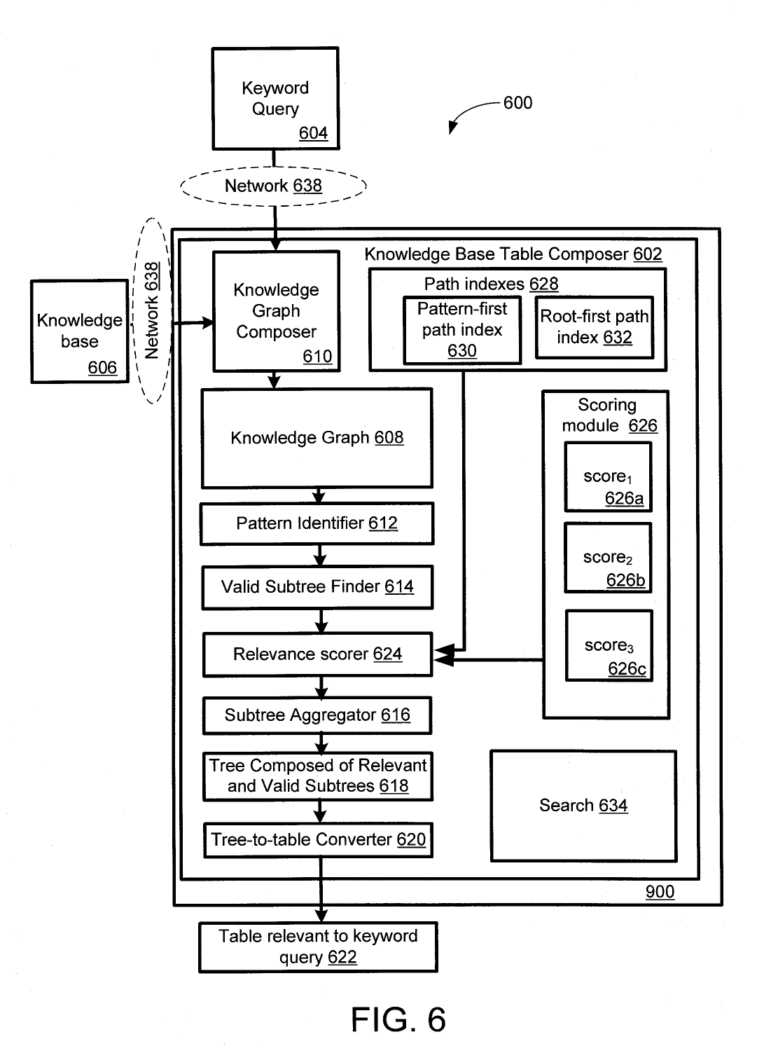

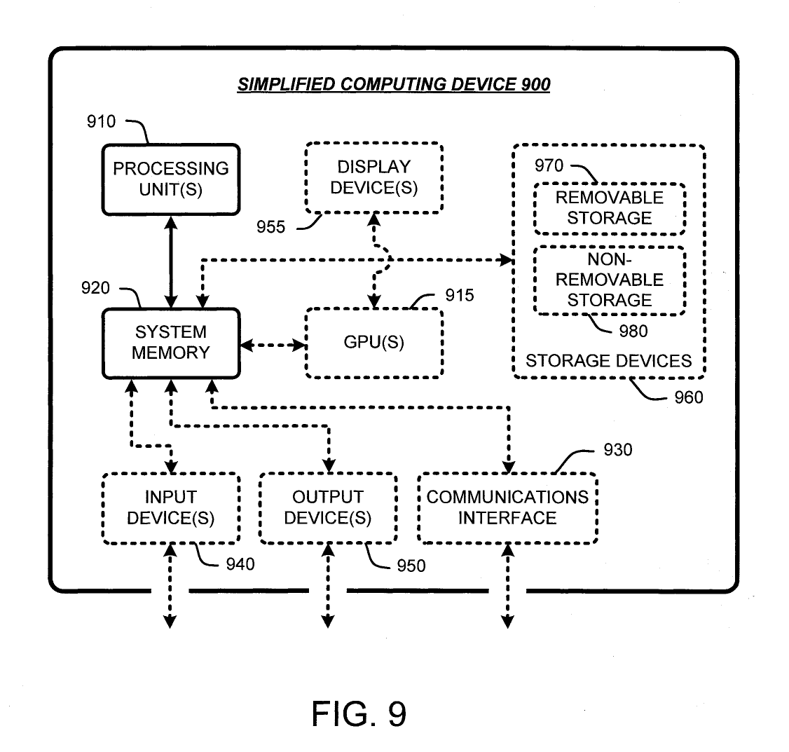

FIG. 6 provides an exemplary system 600 for practicing embodiments of the knowledge base table composer described herein. A knowledge base table composer module 602 resides on a computing device 900 such as is described in greater detail with respect to FIG. 9.

A keyword query 604 of a knowledge base 606 is received at a knowledge base table composer module 602, which resides on a computing device 900 (described in greater detail with respect to FIG. 9). This computing device 900 can be a server or reside on a computing cloud. The keyword query can be obtained over a network 638 for example. The knowledge base 606 may reside on the same computing device 900 as the knowledge base table composer module 602, or reside on a different computing device or in a computing cloud. A knowledge graph 608 is obtained from the knowledge base 606 using a knowledge graph composer module 610. In some embodiments the knowledge graph 608 is a directed graph where each node is an entity with a text description of the value of the entity and its entity type, and where each edge is labeled with a text description of its edge type. It is possible for multiple edges to have the same edge type label.

Patterns of paths in the knowledge graph are found using a pattern identifier module 612 and these patterns are used to find valid subtrees in the knowledge graph 608 using a valid subtree identification module 614. A valid subtree pattern relevant to a keyword query is found by finding a subtree that contains all keywords in a given keyword query in the text description of its node, node type or edge type. The valid subtrees are aggregated into a tree pattern by a subtree aggregator 616. A tree pattern 618 is aggregated from the set of valid subtrees with the same tree structures, entity types and edge types, and positions in the subtrees where keywords are matching. The aggregated tree pattern 618 is input into a tree-to-table converter 620 and is output as a table 622 of joined entities where each row corresponds to a subtree. Where there are multiple possible patterns, they can be enumerated and ranked by their relevance in a relevance scorer 624. For example, the valid subtrees may be scored to measure their relevance to the given keyword query. The relevance score of the tree pattern is an aggregation of the relevance scores of valid subtrees that satisfy the tree pattern. The relevance scorer can use various scoring functions 626a, 626b, 626c in a scoring module 626 to score the tree pattern 618.

Path patterns that contain a certain keyword can be indexed in path indexes 628. Embodiments of the knowledge base table composer can use different types of indexes 628. In one embodiment a pattern-first path index 630 is generated. In this type of index paths are sorted by patterns first and then paths. In this type of pattern-first index 630 it is possible to access the paths in different ways. For example, it is possible to retrieve all path patterns for paths from a root node to a node or an edge that contains a query keyword. It is also possible to retrieve all path patterns for paths form a root node to a node or an edge that contains a query keyword via a given path pattern. Additionally it is also possible to retrieve all path patterns with a given path pattern that start at a root node and end at a node or an edge containing a query keyword.

In another root-first path index 632 paths are sorted by root nodes first and then patterns. In this type of root-first index 632 it is also possible to access the paths in different ways. For example, it is possible to retrieve all root nodes that have paths that can reach a node or edge that contains a query keyword. Likewise, it is possible to retrieve all patterns following which a root node can reach a node or an edge that contains a query keyword. Another possibility is to retrieve all paths that start at a root node and end at a node or edge that contains a query keyword. Finally, it is also possible to retrieve all paths with a given pattern that start at a root node and end at a query keyword. It is possible to aggregate the indexes of path patterns of trees starting from a node or an edge containing some keyword and following a certain pattern.

In any of the indexing methods, a keyword query can be processed by specifying a keyword or a path pattern and using a search module 634 to retrieve a corresponding set of paths.

There are also different ways in which the most relevant tree patterns for a keyword query can be found. In one embodiment of the knowledge base table composer the relevant tree patterns for a keyword query can be found by enumerating combinations of root-leaf path patterns in tree patterns; retrieving paths from the index for each path pattern; and joining the retrieved paths together on the root node to get a set of subtrees satisfying each tree patterns. Alternately, the relevant tree patterns for a keyword query can be found by identifying all candidate root nodes first and enumerating all subtrees containing all keywords with a given candidate root. The enumerated tree patterns are then found by aggregating those subtrees.

1.4 Details and Exemplary Computations

A description of exemplary processes and an exemplary system for practicing the knowledge base table composer having been provided, the following sections provide a description of details and exemplary computations for various knowledge base table composer embodiments. The details and exemplary computations are provided by way of example and are just some of the ways embodiments of the knowledge base table composer can be implemented.

1.4.1. Model and Problem

The graph model of a knowledge base used by embodiments of the knowledge base table composer, called a knowledge graph, is first defined. Then tree patterns, each of which is an answer to a keyword query and is an aggregated set of valid subtrees in the knowledge graph, are also defined. A class of scoring functions used to measure the relevance of a tree pattern to a query is also discussed. Finally, exemplary computations for finding the top-k tree patterns in a knowledge base using keywords are also described.

1.4.1.2 Knowledge Graph

A knowledge base consists of a collection of entities V and a collection of attributes A. Each entity v∈V has values on a subset of attributes, denoted by A(v), and for each attribute A∈A(v), v. A is used to denote its value. The value v. A could be either another entity or some free text. Each entity v∈V is labeled with a type τ(v)∈C, where C is the set of all types in the knowledge base.

The knowledge base can be modeled as a knowledge graph G, with each entity in V as a node, and each pair (v, u) as a directed edge in E if and only if v. A=u for some attribute A∈A(v). Each node v is labeled by its entity type τ(v)=C∈C and each edge e=(v, u) is labeled by the attribute type A if and only if v.A=u, denoted by α(e)=A∈A. So a knowledge graph is denoted by G=(V, E, τ, α) with τ and α as node type and edge type, respectively. There is a text description for each entity/node type C, entity/node v, and attribute/edge type A, denoted by C.text, v.text, and A.text, respectively.

For the remainder of this discussion it is assumed that the value of an entity v's attribute is always an entity in V, because if v.A is plain text, the knowledge base table composer can create a dummy entity with text description exactly the same as the free text.

FIG. 1D shows part of the knowledge graph 130 derived from the knowledge base in FIGS. 1A, 1B and 10. Each node is labeled with its type τ(v) (for example, 132a, 132b, 132c) in the upper part, and its text description is shown in the lower part (for example, 134a, 134b, 134c). For nodes derived from plain text, their types are omitted in the graph. Each edge e is labeled with the attribute type α(e) (for example, 136a, 136b, 136c, 136d, 136e). Note that there could be more than one entity referred in the value of an attribute, e.g., attribute ‘Products’ of entity ‘Microsoft’ (not shown in FIG. 1D). In that case, the knowledge base table composer can create multiple edges with the same label (attribute type) ‘Products’ pointing to different entities, e.g., ‘Windows’ and ‘Bing’.

1.4.2 Finding Top-k Tree Patterns

Tree patterns can be defined as answers for a given keyword query q={w₁, w₂, . . . , wₘ} in a knowledge graph G=(V, E, τ,α). Simply put, a valid subtree with respect to the query q is a subtree in G containing all keywords in the text description of its node, node type, or edge type. A tree pattern aggregates a set of valid trees with the same i) tree structures, ii) entity types and edge types, and iii) positions where keywords are matched.

1.4.2.1 Valid Subtrees for Keyword Queries

A valid subtree T with respect to a keyword query q in a knowledge graph G satisfies three conditions:
(i) T is a directed rooted subtree of G, i.e., it has a root r and there is a directed path from r to every leaf.
(ii) There is a mapping f: q→V(T)∪E(T) from words in q to nodes and edges in the subtree T, such that each word w∈q appears in the text description a node or node type if f(w)∈V(T), and appears in the text description of an edge type if f(w)∈E(T).
(iii) For any leaf v∈V with edge eᵥ∈E pointing to v, there exists w∈q s.t. f(w)=v or f(w)=eᵥ.

Condition ii) ensures that all words appear in a valid subtree T and specifies where they appear. Condition iii) ensures that T is minimal in the sense that, under the current mapping f (from words to nodes or edges wherever they appear), removing any leaf node from T will make it invalid.

A valid tree can be defined as (T, f) if the mapping f is important but not clear from the context.

Consider a keyword query q: “database software company revenue” (w₁-w₄). T₁ in FIG. 1D is a valid subtree with respect to q. The associated mapping f from keywords to nodes in T₁ is: f(w₁)=v₂ (appearing in the text description of node), f(w₂)=v₁ (appearing in the node type), f(w₃)=v₃ (appearing in the node type), and f(w₄)=(v₃, v₄) (appearing in the attribute type). T₁ is minimal and attaching any edge like (v₁, v₆) or (v₃,v₁₁) to T₁ will make it invalid (violating condition iii)). Similarly, T₂ and T₃ are also valid subtrees with respect to q.

1.4.2.2 Tree Patterns: Aggregations of Subtrees

Tree patterns for a keyword query q are now defined. Consider a valid subtree (T, f) with respect to. a keyword query q with the mapping f: q→V(T)∪E(T). For each word w∈q, if w is matched to some node v=f(w), let T(w) be the path from the root r to the node v: v₁e₁v₂e₂ where v₁=r, vₗ=v, and eᵢ is the edge from vᵢ₊₁; and pattern(T(w))=τ(v₁)α(e₁)τ(v₂)α(e₂) . . . α(eₗ₋₁)τ(vₗ) be the types of nodes and the attributes of edges on the path, called path pattern. Similarly, if w is matched to some edge e=f(w), one has the path pattern pattern(T(w))=τ(v₁)α(e₁)τ(v₂)α(e₂) . . . α(eₗ), where eₗ=e. The tree pattern of T with respect to q={w₁, w₂, . . . , wₘ} is:

pattern(T)=(pattern(T(w₁)), . . . , pattern(T(wₘ))) (1)

Patterns of two trees T₁ and T₂ with respect to query q are identical if and only if pattern(T₁(wᵢ))=pattern(T₂(wᵢ)) for any word wᵢ∈q. Valid subtrees are grouped by their patterns. For a tree pattern P, let trees(P, q) be the set of all valid trees with the same pattern P with respect to a keyword query q, i.e., trees(P, q)={T|pattern(T)=P}. trees(P, q) is also written as trees(P) if q is clear from the context.

Sticking with the tree discussed in the paragraph above, tree pattern P₁=pattern(T₁) with respect to query q is visualized in FIG. 2A. In particular, for w₄=‘Revenue’∈q, one has T₁(w₄)=v₁(v₁, v₃)v₃(v₃, v₄), and pattern(T₁(w₄))=(Software) (Developer) (Company) (Revenue). Similarly, for word w₁, one has pattern(T₁(w₁))=(Software) (Genre) (Model), for w₂, pattern(T₁(w₂))=(Software), and pattern(T₁(w₃))=(Software) (Developer) (Company). Combining them together, one gets the tree pattern P₁.

It is easy to see that, in FIG. 1D, T₁ and T₂ have the identical tree pattern P₁, and the tree pattern of T₃ is P₂.

Once the tree pattern P is obtained, it is not hard to convert trees in trees(P) into a table answer. For each tree T∈trees(P), a row is created in the following way: for each word w∈q and path T(w)=v₁e₁v₂e₂ . . . eₗ₋₁vₗ, l columns with values v₁, v₂, . . . , vₗ and column names τ(v₁), τ(v₁)α(e₁)τ(v₂), . . . , and τ(vₗ₋₁)α(eₗ₋₁)τ(vₗ), respectively, are created. From the definition of tree patterns, it is known that all the rows created in this way have the same set of columns and this can be shown in a uniform table scheme. Note that a column may be created multiples times (for different words w's), and redundant columns in the table can be removed. As discussed previously, FIG. 3 shows the table answer 302 derived from tree pattern P₁ 202 in FIG. 2A.

1.4.2.3 Relevance Scores of Tree Patterns

There can be numerous tree patterns with respect to a given keyword query q, so the knowledge base table composer can use scoring functions to measure their relevance. A general class of scoring function can be defined, the higher the more relevant, which can be handled by the procedures introduced later and used by various embodiments of the knowledge base table composer. First, the relevance score of a tree pattern is an aggregation of relevance scores of valid subtrees that satisfy this pattern, e.g., sum and average of scores, or number of trees. The scoring functions shown in equation (2) use a summation, but other aggregation functions could equally well be used.

score(P, q)=τ_{T∈trees(P)}score(T, q). (2)

The relevance score score(T, q) of an individual valid subtree with respect to query q may depend on several factors: 1) score₁(T, q): size of T, small trees are preferred that represent a compact relationship; 2) score₂(T, q): importance score of nodes in T, more important nodes are preferred (e.g., with higher PageRank scores) to be included in T; and 3) score₃(T, q): how well the keywords match the text description in T. Putting these factors together, one has

score(T, q)=score₁(T, q)^{z}^{₁}·score₂(T, q)^{z}^{₂}·score₃(T,q)^{z}^{₃},

where z₁, z₂, and z₃ are constants that determine the weights of each factor. More factors can be inserted into the scoring function. For the completeness, examples for scoring functions score₁, score₂, and score₃ are provided. Note that these can also be replaced by other functions

To measure the size of T, let z₁=−1 and

score₁(T, q)=Σ_{w∈q}score₁(T(w),w)=Σ_{w∈q}|T(w)|, (3)

where |T(w)| is the number of nodes on the path T(w).

To measure how significant nodes of T are, let z₂=1 and

score₂(T, q)=Σ_{w∈q}score₂(T(w),w)=Σ_{w∈q}PR(f(w)), (4)

where PR(f(w)) is the PageRank score of the node that contains word w∈q (or, of the node that has an out-going edge contain word w, if f(w) is an edge).

To measure how well the keywords match the text description in T, let w₃=1 and

score₃(T, q)=Σ_{w∈q}score₃(T(w),w)=Σ_{w∈q}sim(w,f(w)), (5)

where sim(w,f(w)) is the Jaccard similarity between w and the text description on the entity/attribute type of f(w).

Comparing the two tree patterns P₁ 202 and P₂ 204 in FIGS. 2A and 2B with respect to the query q in the example above, it is determined which one is more relevant to q. First, valid subtrees T₁, T₂∈trees(P₁) and T₃∈trees(P₂) in FIG. 1D are considered, T₃ is smaller than T₁ and T₂—to measure the sizes, one has score₁(T₁, q)=score₁(T₂, q)=2+1+2+3=8, and score₁(T₃, q)=1+1+2+3=7. Second, assuming all nodes have the same PageRank scores of 1, one has score₂(T₁, q)=score₂(T₂, q)=score₂(T₃, q)=4. Third, considering the similarity between keywords and text description in valid subtrees T₁, T₂, and T₃, one has score₃(T₁, q)=score₃(T₂, q)=1/2+1+1+1=3.5 and score₃(T₃, q)=1/6+1/6+1+1=2.33. It can be found that while the scoring function prefers smaller trees, it also prefers tree patterns with more valid subtrees and subtrees matching to keywords in text description with higher similarity. So one has score(P₁, q)>score(P₂,q) with z₁=−1 and z₂=z₃=1.

1.4.3 Indexing Path Patterns

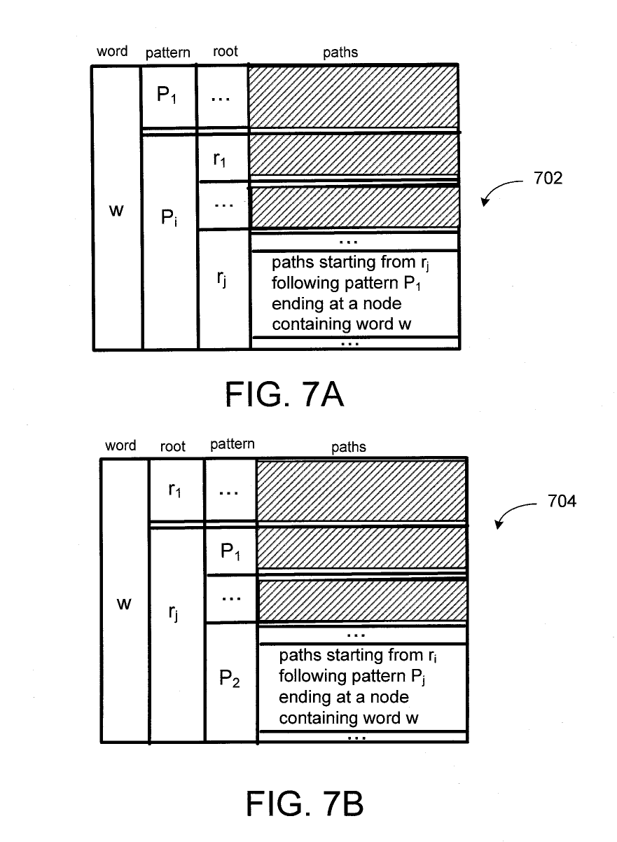

Embodiments of the knowledge base table composer can use path-pattern based indexes. In an index, for each keyword w, all paths materialize starting from some node (root) r in the knowledge graph G, following certain pattern P, and ending at a node or an edge containing w. A word w may be contained in the text description of a node or the type of a node/edge. These paths are grouped by root r and pattern P. Depending on the needs of procedures discussed later, these paths are either sorted by patterns first and then roots (pattern-first path index 702 in FIG. 7A), or by roots first and then patterns (root-first path index 704 in FIG. 7B).

The pattern-first path index 702 of FIG. 7A provides the following methods to access the paths:
Patterns(w): get all patterns following which some root can reach some node/edge containing w.
Roots(w,P): get all roots which reach some node/edge containing w through some path with pattern P.
Paths(w,P,r): get all paths with pattern P starting at root r and ending at some node/edge containing w.

Similarly, the root-first path index 704 of FIG. 7B provides the following methods to access the paths:
Roots(w): get all root nodes which can reach some node/edge containing w.
Patterns(w,r): get all patterns following which the root r can reach some node/edge containing w.
Paths(w,r): get all paths which start at root r and end at some node/edge containing w.
Paths(w,r,P): get all paths with pattern P starting at root r and ending at some node/edge containing W.

The same set of paths are stored in these two types of indexes, but are sorted in different orders. Paths are stored sequentially in memory with pointers at the beginning of a list of paths with the same root r and/or pattern P to support the above access methods.

Note that the terms |T(w)|, PR(f(w)), and sim(w,f(w)) in the relevance-scoring functions (3)-(5) can be also easily materialized in the path index, so that the overall score (2) can be computed efficiently for a tree pattern.

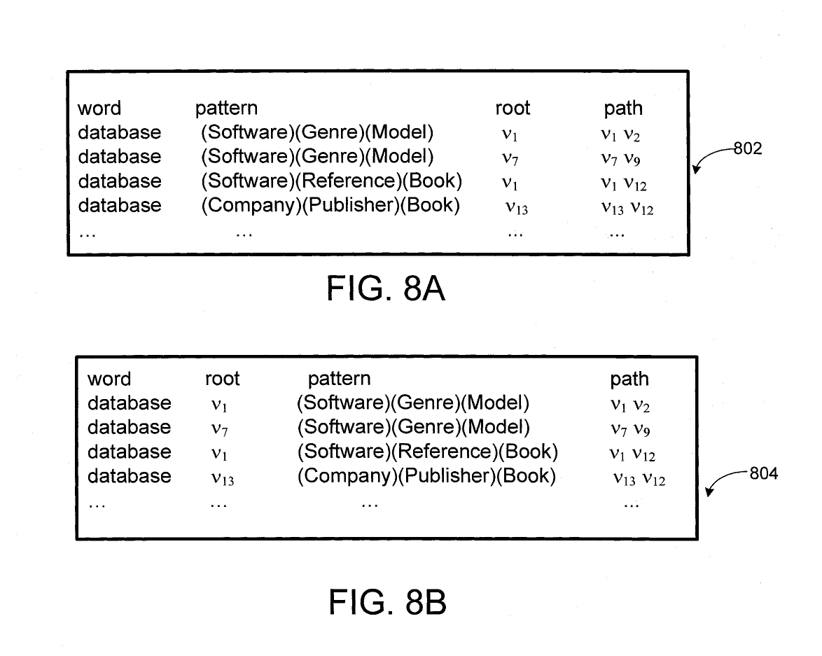

For the knowledge graph in FIG. 1D, FIGS. 8A and 8B shows the two types of indexes on word w=“database”. For the pattern-first path index 802 in FIG. 8A, Patterns(w) returns three patterns. Consider the pattern P₁=(Software) (Reference) (Book), Roots(w,P₁) returns one root {v₁}. For the root-first path index 804 in FIG. 8B, Roots(w) returns three roots {v₁, v₇, v₁₃}. Patterns(w,r₁) returns two patterns. Consider the pattern P₂=(Software) (Genre) (Model), Paths(w,v₁,P₂) returns one path {v₁v₂}. Finally, it can be shown that the size of the path index is bounded by the total number of paths in consideration and the size of text on entities and attributes.

1.4.3.3 Pattern Enumeration-Join Approach

From the definition of a tree pattern in Equation (1), one can see that the tree pattern is composed of m path patterns if there are m keywords in the query. The procedure shown in Procedure 1 finds the top-k tree patterns and valid subtrees for a keyword query using the indexes. This procedure enumerates the combinations of these m path patterns in a tree pattern using the pattern-first path index; for each combination, retrieves paths with these patterns from the index, and joins them at the root to check whether the tree pattern is empty (i.e., whether there is any valid subtree with this pattern). For the nonempty ones, their tree answers trees(P)'s and scores are then computed using the same index.

The procedure, named as PatternEnum, is described in Procedure 1. It first enumerates the root type of a tree pattern in line 2. For each root type C, it then enumerates the combinations of path patterns starting from C and ending at keywords wᵢ's in lines 4-8. Each combination of m path patterns forms a tree pattern P, but it might be empty. So lines 5-6 check whether trees(P) is empty again using the path index in lines 7-8. For each nonempty tree pattern, its score and tree answers are computed and inserted into the queue Q in line 8. After every root type is considered, the top-k tree patterns in Q can be output.

Procedure 1. PatternEnum: Finding top-k tree patterns and valid
subtrees for a keyword query

```
    Input: knowledge graph G, with pattern-first path index, and keyword
query q = {w₁, ..., wₘ}
    1. Initialize a queue Q of tree patterns, ranked by scores.
    2. For each type C ∈ C
    3. Let Patterns_{C}(wᵢ) be the set of path patterns
      rooted at the type C in Patterns(wᵢ)
    4. For each tree pattern P = (P₁, ..., Pₘ)
              ∈ Patterns_{C}(w₁) x ... x Patterns_{C}(wₘ)
        Check whether trees(P) is empty:
    5. Compute candidate roots R ← ∩ᵢ₌₁^{m} Roots(wᵢ, Pᵢ)
    6. If R ≠ Ø then
    7. trees(P) ← U_{r∈R} Paths(w₁, P₁, r)
                      × ... × Paths(wₘ, Pₘ, r);
    8. Compute score(P, q) and insert P into queue Q
            (only need to maintain k tree patterns in Q)
    9. Return the top-k tree patterns in Q and tree answers.
```

Consider a query “database software company revenue” with four keywords w₁-w₄ in the knowledge graph in FIG. 1D. When the root type C=Software, one has two path patterns (Software) (Genre) (Model) and (Software) (Reference) (Book) from Patterns_{C}(w₁), as in FIG. 8A. To form the tree pattern in FIG. 2A, in line 4, the first path pattern from Patterns_{C}(w₁), (Software) from Patterns_{C}(w₂), (Software) (Developer) (Company) from Patterns_{C}(w₃), and (Software) (Developer) (Company) (Revenue) from Patterns_{C}(w₄). The knowledge base table composer then finds this tree pattern is not empty, and paths in the index with these patterns can be joined at nodes v₁ and v₇, forming two tree answers T₁ and T₂, respectively, in FIG. 1D.

Procedure 1, PatternEnum, is efficient especially for queries which have relatively small numbers of tree patterns and tree answers. The advantage of this procedure is that valid subtrees with the same pattern are generated at one time, so no online aggregation is needed. The path index has materialized aggregations of paths which can be used to check whether a tree pattern is empty and to generate tree answers. Also, it keeps at most k tree patterns and associated valid subtrees in memory and thus has very small memory footprint.

However, in the worst case, Procedure 1's running time is still exponential both in the size of index and in the number of valid subtrees, mainly because costly set-intersection operators are wasted on empty tree patterns (line 5). Consider such a worst-case example: In a knowledge graph, one has two nodes r₁ and r₂ with the same type C; r₁ points to p nodes v₁, . . . , vₚ of types C₁, . . . , Cₚ through edges of types A₁, . . . , Aₚ; and r₂ points to another p nodes vₚ₊₁, . . . , v₂ₚ of types Cₚ₊₁, . . . , C₂ₚ through edges of types Aₚ₊₁, . . . , A₂ₚ. One has two words w₁ and w₂, w₁ appearing in v₁, . . . , vₚ and w₂ appearing in vₚ₊₁, . . . , v₂ₚ. To answer the query {w₁, w₂}, procedure PatternEnum enumerates a total of p² combined tree patterns (CAᵢCᵢ, . . . , CAⱼCⱼ)'s for i=1, . . . , p and j=p+1, . . . , 2p, but they are all empty. So its running time is Θ(p²) or Θ(p^{m}) in general for m keywords, where p is in the same order as the size of the index and Θ( ) is a notation of complexity.

1.4.5 Linear-Time Enumeration Approach

This section describes how the knowledge base table composer can enumerate tree patterns for a given keyword query using the root-first path index in this subsection. The procedure introduced here is optimal for enumeration in the sense that its running time is linear in the size of the index and linear in the size of the answers. It can also be extended for finding the top-k, and can be sped up by using sampling techniques.

The procedure, Procedure 2, herein named LinearEnum, is based on the following idea: instead of enumerating all the tree patterns directly, the knowledge graph table composer starts with enumerating all possible roots for valid subtrees, and then assembles trees from paths by looking up the path index with these roots.

These candidate roots, denoted as R, can be found based on the simple fact that a node in the knowledge graph is the root of some tree answer if and only if it can reach every keyword at some node. So the set R can be obtained by taking the intersection of Roots(w₁), . . . , Roots(wₘ) from the root-first path index (line 1).

For each candidate root r, recall that, using the path index, Patterns(wᵢ, r) retrieves all patterns following which r can reach keyword wᵢ at some node. So pick any pattern Pᵢ∈Patterns(wᵢ,r) for each wᵢ, P=(P₁, . . . , Pₘ) is a nonempty tree pattern (i.e., trees(P)≠). Line 7 of subroutine ExpandRoot the procedure gets all such patterns. Each P must be nonempty (with at least one tree answer), because by picking any path pᵢ from Paths(wᵢ, r, Pᵢ) for each Pᵢ, one can get a valid subtree (p₁, . . . , pₘ) with pattern P, as in line 10. Note that tree answers with pattern P may be under different roots, so one needs a dictionary, TreeDict in line 11, to maintain and aggregate the valid subtrees along the whole process. Finally, TreeDict[P] is the set of valid subtrees with pattern P as in lines 5-6.

Consider a query “database software company revenue” with four keywords w₁-w₄ in the knowledge graph in FIG. 1D. The candidate roots one gets are {v₁, v₇, v₁₂} (line 1 of Procedure 2). For v₁ and w₁=“database”, one can get two path patterns from Patterns(w₁,v₁): (Software) (Genre) (Model), and (Software) (Reference) (Book). Picking the first one, together with patterns (Software), (Software) (Developer) (Company), and (Software) (Develop) (Company) (Revenue) for the other three keywords “software”, “company”, ‘revenue”, respectively, one can get the tree pattern in FIG. 2A (one of T obtained in line 7). This pattern must be nonempty, because one can find a valid subtree under v₁ by assembling the four paths v₁v₂, v₁, v₁v₃, and v₁v₃v₄ into a subtree T₁ in FIG. D (line 10).

Another tree answer, T₂ in FIG. 1D, with the same pattern can be found later when candidate root v₇ is considered. They are both maintained in the dictionary TreeDict.

Procedure 2: LinearEnum: Enumerating all tree patterns and valid
subtrees for a keyword query

```
      Input: knowledge graph G, root-first path indexes, and keyword
query q = {w₁, ..., wₘ}
    1. Compute candidate roots R ← ∩ᵢ₌₁^{m} Roots(wᵢ).
    2. Initialize a dictionary TreeDict[ ].
    3. For each candidate root r ∈ R
    4. Call ExpandRoot(r, TreeDict[ ]).
    5. For each tree pattern P, trees(P) ← TreeDict[P].
    6. Return tree patterns and tree answers in trees(•).
  Subroutine ExpandRoot( root r, dictionary TreeDict[ ])
          Pattern Product:
    7. T ← Patterns(w₁, r) × ... × Patterns(wₘ, r);
    8. For each tree pattern P = (P₁, ..., Pₘ) ∈ T
        Path Product:
    9. For each (p₁, ..., pₘ) ∈
                Paths(w₁, r, P₁) × ... × Paths(wₘ, r, Pₘ)
    10. Construct tree T from the m paths p₁, ..., pₘ;
    11. TreeDict[P] ← TreeDict[P] ∪ {T}.
```

Procedure LinearEnum is optimal in the worst case because it does not waste time/operators on invalid tree patterns. Every tree pattern it tries in line 8 has at least one valid subtree. And to generate each valid subtree, the time it needs is linear in the size of the tree (line 10).

1.4.5.1 Partitioning by Types to Find Top-k

How embodiments of the knowledge base table composer extend LinearEnum in Procedure 2 to find the top-k tree patterns (with the highest scores) will now be discussed. One method is to compute the score score(P, q) for every tree pattern after LinearEnum is run for the given keyword query q on the knowledge graph G. However, the dictionary TreeDict[ ] used in the procedure could be very large (may not fit in memory and may incur higher random-access cost for lookups and insertions), as it keeps every tree patterns and associated valid subtrees, but the knowledge base table composer only requires the top-k.

Another procedure that can be used is to apply LinearEnum for candidate roots with the same type at one time. For each type C, LinearEnum is applied only for candidate roots with type C (only line 3 of Procedure 2 needs to be changed); then the scores of resulting tree patterns/answers are computed but only the top-k tree patterns are kept; and the process is repeated for another type. In this way, the size of the dictionary TreeDict[ ] is upper-bounded by the number of valid subtrees with roots of the same type, which is usually much smaller than the total number of valid subtrees in the whole knowledge graph.

For example, for the knowledge graph and the keyword query in FIG. 1D, the tree pattern P₁ in FIG. 1D is found and scored when LinearEnum is applied for the type “Software”, and P₂ in FIG. 1D is found and scored when the type “Book” is considered as the root. This idea, together with the sampling technique introduced a bit later, will be integrated in LinearEnum-TopK for finding the top-k tree patterns.

Procedure 3. LinearEnum-TopK (Λ, ρ): partitioning by types and
sampling roots to find the top-k tree patterns

```
    Input: knowledge graph G, with both path indexes, and keyword
query q = {w₁, ..., wₘ}
    Parameters: sampling threshold Λ and sampling rate ρ
    1. Initialize a queue Q of tree patterns, ranked by scores.
    2. For each type C among all types C
    3. Compute candidate roots of type C:
        R = (∩ᵢ₌₁^{m} Roots(wᵢ)) ∩ C;
    4. Compute the number of tree answers rooted in R:
        N_{R} = Σ_{r∈R} Πᵢ₌₁^{m} |Paths(wᵢ, r)|;
    5. If N_{R} ≧ Λ let rate = ρ else rate = 1;
    6. Initialize dictionary TreeDict[ ];
    7. For each candidate root r ∈ R,
    8. With probability rate,
        call ExpandRoot(r, TreeDict[ ]),
    9. For each tree pattern P rooted at C in TreeDict
    10. Compute estimated score:
                      ŝ(P, q) = Σ_{T∈TreeDict[P]} score(T, q); (6)
    11. For each P with the top-k estimated score ŝ,
        Compute the exact score score(P, q) and
        insert P into the queue Q (with size at most k);
    12. Return the top-k tree patterns in Q and tree answers.
```

1.4.5.2 Speedup by Sampling

The two most costly steps in LinearEnum are in subroutine ExpandRoot: i) the enumeration of tree patterns in the product of Patterns(wᵢ,r)'s (line 7); and ii) the enumeration of tree answers in the product of Paths(wᵢ,r,Pᵢ)'s (line 9). Too many valid subtrees could be generated and inserted into the dictionary TreeDict[ ] which is costly in both time and space. In the following description, how to use sampling techniques to find the top-k tree patterns more efficiently is introduced (but with probabilistic errors).

In some embodiments of the knowledge base table composer, instead of computing the valid subtrees for every root candidate (subroutine ExpandRoot in Procedure 2), the knowledge base table composer does so only for a random subset of candidate roots—each candidate root is selected with probability p. Then equivalently, for each tree pattern P, only a random subset of valid subtrees in trees(P) are retrieved (kept in TreeDict[P]), and the knowledge base table composer can use this random subset to estimate score(P, q) as ŝ(P,q). Now, the knowledge base table composer only needs to maintain tree patterns with the top-k estimated scores, without keeping the complete set of valid subtrees in trees(P) for each pattern. Finally, the knowledge base table composer computes the exact scores and the complete sets of valid subtrees only for the top-k tree patterns, and re-ranks them before outputting them.

A detailed exemplary version of this procedure, called LinearEnum-TopK, is described in Procedure 3. In addition to the input knowledge graph and keyword query, there are two more parameters Λ and ρ. The type of roots in a tree pattern in line 2 are first enumerated. For each type, similar to LinearEnum, candidate roots of this are computed in line 3. The knowledge base table composer can compute the number of valid subtrees (possibly from different tree patterns) with these roots as N_{R} in line 4, without really enumerating them. To this end, the knowledge base table composer only needs to get the number of paths starting from each candidate root r and ending at each keyword wᵢ. Only when the number of tree answers is no less than Λ, the root sampling technique in lines 7-8 is applied with rate=ρ (otherwise rate=1): for each candidate root r, with probability rate, the knowledge base table composer computes the tree answers under it and inserts them into the dictionary TreeDict[ ] (subroutine ExpandRoot in Procedure 2 is re-used for this purpose). After all candidate roots of a type are considered, in lines 9-10, the knowledge base table composer can compute the estimated score as ŝ(P, q) for each tree pattern P in TreeDict. Only for tree patterns with the top-k estimated scores, their valid subtrees with exact scores are computed and inserted into a global queue Q in line 11 to find the global top-k.

The running time of LinearEnum-TopK can be controlled by parameters Λ and ρ. Sampling threshold Λ specifies for which types of roots, the tree answers are sampled to estimate the pattern scores. By setting Λ=+∞ and ρ=1 (no sampling at all), one can get the exact top-k. When Λ<+∞ and ρ<1, the algorithm is sped up but there might be errors in the top-k answers.

### 2.0 Exemplary Operating Environment:

The knowledge base table composer embodiments described herein are operational within numerous types of general purpose or special purpose computing system environments or configurations. FIG. 9 illustrates a simplified example of a general-purpose computer system on which various embodiments and elements of the knowledge base table composer, as described herein, may be implemented. It is noted that any boxes that are represented by broken or dashed lines in the simplified computing device 900 shown in FIG. 9 represents alternate embodiments of the simplified computing device. As described below, any or all of these alternate embodiments may be used in combination with other alternate embodiments that are described throughout this document. The simplified computing device 900 is typically found in devices having at least some minimum computational capability such as personal computers (PCs), server computers, handheld computing devices, laptop or mobile computers, communications devices such as cell phones and personal digital assistants (PDAs), multiprocessor systems, microprocessor-based systems, set top boxes, programmable consumer electronics, network PCs, minicomputers, mainframe computers, and audio or video media players.

To allow a device to implement the knowledge base table composer embodiments described herein, the device should have a sufficient computational capability and system memory to enable basic computational operations. In particular, the computational capability of the simplified computing device 900 shown in FIG. 9 is generally illustrated by one or more processing unit(s) 910, and may also include one or more graphics processing units (GPUs) 915, either or both in communication with system memory 920. Note that that the processing unit(s) 910 of the simplified computing device 900 may be specialized microprocessors (such as a digital signal processor (DSP), a very long instruction word (VLIW) processor, a field-programmable gate array (FPGA), or other micro-controller) or can be conventional central processing units (CPUs) having one or more processing cores.

In addition, the simplified computing device 900 shown in FIG. 9 may also include other components such as a communications interface 930. The simplified computing device 900 may also include one or more conventional computer input devices 940 (e.g., pointing devices, keyboards, audio (e.g., voice) input devices, video input devices, haptic input devices, gesture recognition devices, devices for receiving wired or wireless data transmissions, and the like). The simplified computing device 900 may also include other optional components such as one or more conventional computer output devices 950 (e.g., display device(s) 955, audio output devices, video output devices, devices for transmitting wired or wireless data transmissions, and the like). Note that typical communications interfaces 930, input devices 940, output devices 950, and storage devices 960 for general-purpose computers are well known to those skilled in the art, and will not be described in detail herein.

The simplified computing device 900 shown in FIG. 9 may also include a variety of computer-readable media. Computer-readable media can be any available media that can be accessed by the computer 900 via storage devices 960, and can include both volatile and nonvolatile media that is either removable 970 and/or non-removable 980, for storage of information such as computer-readable or computer-executable instructions, data structures, program modules, or other data. Computer-readable media includes computer storage media and communication media. Computer storage media refers to tangible computer-readable or machine-readable media or storage devices such as digital versatile disks (DVDs), compact discs (CDs), floppy disks, tape drives, hard drives, optical drives, solid state memory devices, random access memory (RAM), read-only memory (ROM), electrically erasable programmable read-only memory (EEPROM), flash memory or other memory technology, magnetic cassettes, magnetic tapes, magnetic disk storage, or other magnetic storage devices.

Retention of information such as computer-readable or computer-executable instructions, data structures, program modules, and the like, can also be accomplished by using any of a variety of the aforementioned communication media (as opposed to computer storage media) to encode one or more modulated data signals or carrier waves, or other transport mechanisms or communications protocols, and can include any wired or wireless information delivery mechanism. Note that the terms “modulated data signal” or “carrier wave” generally refer to a signal that has one or more of its characteristics set or changed in such a manner as to encode information in the signal. For example, communication media can include wired media such as a wired network or direct-wired connection carrying one or more modulated data signals, and wireless media such as acoustic, radio frequency (RF), infrared, laser, and other wireless media for transmitting and/or receiving one or more modulated data signals or carrier waves.

Furthermore, software, programs, and/or computer program products embodying some or all of the various knowledge base table composer embodiments described herein, or portions thereof, may be stored, received, transmitted, or read from any desired combination of computer-readable or machine-readable media or storage devices and communication media in the form of computer-executable instructions or other data structures.

Finally, the knowledge base table composer embodiments described herein may be further described in the general context of computer-executable instructions, such as program modules, being executed by a computing device. Generally, program modules include routines, programs, objects, components, data structures, and the like, that perform particular tasks or implement particular abstract data types. The knowledge base table composer embodiments may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Additionally, the aforementioned instructions may be implemented, in part or in whole, as hardware logic circuits, which may or may not include a processor.

### 3.0 Other Embodiments

It should also be noted that any or all of the aforementioned alternate embodiments described herein may be used in any combination desired to form additional hybrid embodiments. Although the subject matter has been described in language specific to structural features and/or methodological acts, it is to be understood that the subject matter defined in the appended claims is not necessarily limited to the specific features or acts described above. The specific features and acts described above are disclosed as example forms of implementing the claims.

What is claimed is:

1. A computer-implemented process for composing tables from a knowledge base using a keyword query, comprising:
receiving a keyword query for a table of data as an answer;
using patterns of structured data in a knowledge graph obtained from a knowledge base to create one or more tables with data relevant to the keyword query.

2. The computer-implemented process of claim 1 wherein the one or more tables are assembled from subtrees of the knowledge graph.

3. The computer-implemented process of claim 2 wherein assembling the tables from the sub-graphs of the knowledge graph further comprises:
grouping subtrees of the knowledge graph that are connected trees that have the same pattern and the same mapping of keywords to column names, table names and cell values of the same table.

4. A computer-implemented process for providing relevant tables in response to a keyword query, comprising:
receiving a keyword query;
obtaining a knowledge graph with nodes representing entities of different types and edges representing relationships between the entities from a knowledge base;
using keywords from the keyword query in the knowledge graph to find relevant subtrees in the knowledge graph;
aggregating a tree pattern from the set of valid subtrees with the same tree structures, entity types and edge types, and positions in the subtrees where keywords are matching; and
outputting the aggregated tree pattern as a table of joined entities where each row corresponds to a subtree.

5. The computer-implemented process of claim 4 wherein the knowledge graph is a directed graph wherein each node is an entity that is labeled with a text description of the value of the entity and its entity type, and wherein each edge is labeled with a text description of its edge type.

6. The computer-implemented process of claim 5 wherein multiple edges have the same edge type label.

7. The computer-implemented process of claim 5 wherein a subtree pattern relevant to a keyword query is found by finding a subtree that contains all keywords in a given keyword query in the text description of its node, node type or edge type.

8. The computer-implemented process of claim 7 further comprising aggregating a tree pattern from a set of valid subtrees with the same i) tree structures, ii) entity types and edge types and iii) positions in the subtrees where keywords are matching.

9. The computer-implemented process of claim 8 wherein the valid subtrees are scored to measure their relevance to the given keyword query.

10. The computer-implemented process of claim 9 wherein the relevance score of a tree pattern is an aggregation of relevance scores of valid subtrees that satisfy a tree pattern.

11. The computer-implemented process of claim 4 further comprising indexing path patterns that contain a keyword.

12. The computer-implemented process of claim 11 further comprising generating a pattern-first path index wherein the paths are sorted by patterns first and then paths, and wherein the following methods can be used to access the paths:
retrieving all path patterns for paths from a root node to a node or edge that contains a query keyword;
retrieving all path patterns for paths from a root node to a node or edge that contains a query keyword via a given path pattern;
retrieving all path patterns with a given path pattern that start at a root node and end at a node or edge containing a query keyword.

13. The computer-implemented process of claim 11 further comprising generating a root-first path index wherein the paths are sorted by root nodes first and then patterns, and wherein the following methods can be used to access the paths:
retrieving all root nodes that have paths that can reach a node or edge that contains a query keyword;
retrieving all patterns following which a root node can reach a node or an edge that contains a query keyword;
retrieving all paths that start at a root node and end at a node or edge that contains a query keyword;
retrieving all paths with a given pattern that start at a root node and end at a node or edge that contains a query keyword.

14. The computer-implemented process of claim 11 further comprising aggregating the indexes of path patterns of trees starting from some root and ending at a node/edge containing some keyword and following a certain pattern.

15. The computer-implemented process of claim 12 further comprising processing a keyword query by specifying the keyword or the path pattern and using a search procedure to retrieve the corresponding set of paths.

16. The computer-implemented process of claim 10 wherein the relevant tree patterns for a keyword query are found by:
enumerating combinations of root-leaf path patterns in tree patterns;
retrieving paths from the index for each path pattern; and
joining the retrieved paths together on the root node to get a set of subtrees satisfying each tree pattern.

17. The computer-implemented process of claim 10 wherein the relevant tree patterns for a keyword query are found by:
identifying all candidate root nodes using indexes;
enumerating all tree patterns containing a subtree with a given candidate root;
aggregating the enumerated tree patterns.

18. A system for creating tables from keyword queries, comprising:
a computing device;
a computer program comprising program modules executable by the computing device, wherein the computing device is directed by the program modules of the computer program to:
obtain a knowledge graph in the form of a directed graph where nodes represent entities and edges represent the relationships among the entities;
find a pattern that is an aggregation of subtrees which contain all keywords of a keyword query and have the same structure and types on node and edges; and
convert the aggregation of subtrees into a table.

19. The computer-implemented process of claim 18 further comprising using scoring functions to find patterns that are relevant to the keyword query.

20. The computer-implemented process of claim 18 further comprising using path-based indexes to find the patterns.
